(19) United States
(12) Patent Application Publication
(10) Pub. No.: US 2025/0185535 A1
(43) Pub. Date: Jun. 12, 2025

(54) METHOD AND SYSTEM FOR OPERATING A SOLAR ROBOT WITH A CHARGING POSITION MARKER

(71) Applicant: HUSQVARNA AB, Huskvarna (SE)

(72) Inventors: Martin HAMMARSTROM, Jonkoping (SE); Par-Ola SVENSSON, Foreserum (SE)

(21) Appl. No.: 18/845,702

(22) PCT Filed: Mar. 9, 2023
(86) PCT No.: PCT/SE2023/050218

§ 371 Date: Sep. 10, 2024

(30) Foreign Application Priority Data
Mar. 21, 2022 (SE) 2250351-0

(51) Int. Cl. A01D 34/00; A01D 101/00; B60L 53/37; B60L 53/51

(52) U.S. Cl. CPC A01D 34/008; B60L 53/37; B60L 53/51; A01D 2101/00

(57) ABSTRACT

A method for operating at least one autonomous robot (2), in particular an autonomous vegetation working robot, preferably an autonomous lawn robot, within an operating area, the robot comprising (i) at least one electrically driven tool, (ii) at least one electric motion drive for moving the robot, and (iii) at least one photoelectric device for converting energy from illuminating light, in particular sunlight, into electric energy for the tool and the motion drive, and (iv) at least one energy storage for storing electric energy charged by the photoelectric device and for sup-plying the tool and the motion drive with electric energy, the method comprising the steps of a) the robot (2) working in an autonomous working mode within at least one working area (15) within the operating area, b) determining an electric energy stored in the energy storage of the robot or a directly associated electric quantity such as electric capacity or electric charge of the energy storage, c) if the determined stored energy or the directly associated electric quantity of the energy storage is below a minimum operating threshold, the robot moves or is moved to a charging position (CP, WP) for recharging the energy storage using the photoelectric device, d) wherein the charging position (CP, WP) is chosen from one or more charging positions, where, at least for a minimum recharging time period, the illumination intensity of the illuminating light will be higher than a high illumination threshold and/or where the illuminating light will essentially not be shaded by objects in or around the operating area, in particular vegetation objects such as hedges, bushes or trees or built objects such as buildings, e) wherein the or each charging position (CP) is defined by a corresponding position marker (5) placed at the charging position, f) wherein the robot, when moving or being moved to the charging position, searches for the position marker (5) by means of a sensing device (25) and stops at the charging position within a certain distance from the position marker (5).

### FIELD OF TECHNOLOGY

The invention relates to a method for operating an autonomous robot, in particular an autonomous vegetation working robot such as an autonomous lawn robot and to an autonomous robot system.

### BACKGROUND OF THE INVENTION

Autonomous lawn robot systems are used for keeping a lawn (or: grass surface) permanently cut or mowed (with autonomous lawn mowers or lawn mowing robots) and, in some cases, for maintaining the lawn in other ways such as mulching, scarifying, irrigating or fertilizing.

Such autonomous lawn robots are autonomous (or: independent) with regard to the navigation within a specified lawn area and with regard to energy supply, so that no human supervision or interaction is necessary for navigating the robot or providing the robot with energy.

For an autonomous navigation of a robot a variety of features need to be implemented to make the navigation independent of humans and yet fully reliable, including in particular sensing and using real time signals from external systems such as bordering wires, guide wires, antennas or beacons, using known positioning systems and also using mapping of the area. A special mapping navigational system is disclosed in WO 2021/209277 A1.

For an autonomous energy or power supply the known systems mainly use electric energy and rechargeable batteries as energy storage carried by the robot which supply the electric consumers in the robot, in particular the cutting or mowing system, the drive system and the control unit and display with the electric energy needed.

The size and type of the rechargeable batteries and the corresponding battery management system are usually selected empirically on a case by case basis and a compromise between inter alia (i) the weight, (ii) the maximum power (peak power) needed especially for the cutting and driving and for the controlling and sensing and (iii) the charging capacity, i.e. the overall energy that is needed for a specified lawn area to be maintained. Usually, autonomous lawn mowing robots are operated or set on pre-mowed or low height lawns and afterwards by their permanent (or: continuous or steady) autonomous operation keep the height of the lawn low also in the growth period. Therefore, the maximum electric power needed for mowing and also driving and thus the size and weight of the batteries can be kept low.

For recharging the rechargeable batteries of a lawn robot it is known to use charging stations connected to mains, e.g. as disclosed in EP 1 302 147 B1 or EP 2 547 191 B1 or photoelectric charging with solar cells on the robot or hybrid solutions of both.

In solutions using photovoltaic (or: photoelectric) cells or modules carried by the lawn robot the surrounding or illuminating light, usually sunlight, is converted into electric energy which is fed to and stored in the rechargeable batteries. Such an autonomous lawn robot driven by solar energy (or: solar-driven robot) does not need to return to a charging station for recharging, but will also not be supplied with new energy when there is no or not enough sunlight, such as during the night or during rain or mist. However, the season a lawn robot is most needed is the growth season when there is the most sunlight, so from the perspective of availability of solar energy a solar driven lawn robot is an ideal match.

One of the tasks when using solar energy for autonomous robots is to keep the robot in the sun or exposed to the sunlight for long enough a time, so that the solar energy can be used directly during operation and also for sufficiently recharging the batteries. In particular, it is a task to stay out of shadow or shade by objects in or around the lawn area to be maintained, or only stay in the shade for a minimum time to maintain the lawn if necessary but then to leave the shade and to revert to an area lit by unshaded sunlight again.

A solar-driven autonomous lawn robot was proposed in U.S. Pat. No. 5,444,965 A and put into practice in the SolarMower sold by Husqvarna already in the 1990ties. A shade detection system was provided to avoid that the robot remains a long time in a shaded zone. If the fall of energy caused by the passing of one row of cells from sun to shade exceeds a predetermined value, considered as a signal of entry into shaded zone, the robot continues its movement over a certain distance and if the energy received remains at its reduced level, the robot turns back to return to the sunny zone. An energy management system manages the state of charge of the battery and detects nocturnal periods and places the system in a waiting state with minimum consumption. The battery allows the operation of the electronics also in the darkness or the operation of the mower in shaded zones or during cloudy intervals and evening out the photovoltaic energy. When the voltage at the battery decreases below a critical value, the robot is stopped and waits until the voltage increases to an acceptable value and then may be started again. Before entering the waiting state the robot verifies that it is not in a shaded zone and if a shaded zone has been detected, the robot finishes the shade leaving routine before stopping. When night falls, the current coming from all photovoltaic cells decreases and fades out.

WO 2015/094054 A1 discloses a robotic work tool system with a robotic work tool, in particular an autonomous lawn robot, comprising a satellite position determination, wherein an obstacle map is generated to determine when an area will be shadowed with regards to satellite reception based on said obstacle map the operation of the robotic work tool is scheduled accordingly. The obstacle map is a shadow map giving information on areas that are at least partially shadowed at specific times. When the robotic work tool is solar charged a shadow map is generated as well. The robotic work tool determines that an area is shadowed from the sun by a (sudden) drop in voltage over a solar panel which indicates that the robotic work tool has entered a shadowed area. The sun's position and movement is, as for the satellites, known and can be determined for future operations based on said shadow map. The robotic work tool generates as a shadow map an obstacle map indicating when certain areas will be shadowed with regards to the sun, and schedule its operation accordingly so that the robotic work tool is exposed to as much sunlight as possible during an operation.

EP 3 503 205 B1 discloses an automatic working system with a self-moving device, configured to move and work in a working area and comprising a photoelectric conversion unit (solar panel and converter) and an energy storage unit (batteries), configured to store the electric energy obtained from the photoelectric conversion unit, and a control module that receives positioning information and illumination intensity information at one or more locations of the self-moving device in the working area, and generates an illumination map of the working area based on the received positioning information and illumination intensity information and on time. The illumination map may also contain attitude information of the device at the locations. The illumination intensity information is obtained from an illumination sensor or by estimating an output voltage of the photoelectric conversion unit. In a charging mode the self-moving device is moved, based on the illumination map, to a location at which illumination intensity satisfies a preset level and that is closest to a current location and the device recharges its batteries. In the charging mode the self-moving device changes, by rotating the solar panel on the device or by rotating the whole device, an angle at which the photoelectric conversion unit receives optical energy, and determines an optimal solar radiation angle. Weather information obtained through the Internet may be used as illumination condition information. Furthermore, a stored season model comprising illumination condition information of different regions and different time periods can also be obtained based on the actual geographic location and date information of the working area. The illumination map may also contain attitude information of the device at the locations.

US 2015/0359185 A1 discloses an irrigation mobile robot having a battery and a sloped photovoltaic panel and a positioning system using radio signals from moisture beacons and historical movement vectors and a camera vision system. When an irrigation cycle is completed, the mobile robot recharges its battery using solar energy. Use of solar energy is optimized by moving the robot to a location in the working area that provides the brightest sun based on historical information, the time of day, and the calendar date. The mobile robot rotates on its axis so that the photovoltaic panel faces the sun as the sun's position in the sky changes. As charging continues, the mobile robot determines based on historical information for that time of day whether there is a location offering brighter. Sun brightness may be determined by historical photovoltaic panel output power or by an ambient light sensor. When charging is complete the cycle ends and the mobile robot enters a low power hibernate state until the next irrigation cycle. During the hibernate state the radio receiver in the control module is still active allowing reception of periodic moisture messages from the moisture beacons.

WO 2018/215092 A1 discloses a method of configuring a charging system as part of an energetically autonomous sustainable intelligent robot using a computer vision based system and an artificial intelligence system to track and learn the best charging spots, for example, the best locations in the garden to charge the robot by means of a solar panel mounted on the robot. Based on location, time and weather, the robot inspects and measures how much sun falls on a given location of the map. Obstacles causing shadows are taken into account when measuring. Based on the available spots, and the real time weather, the robot calculates and estimates the best charging times and locations. It is not disclosed in more detail how this is accomplished in practice.

CN 104393359 A discloses an intelligent smart home cleaning robot for automatically cleaning the floor in a room. When this known smart robot is active within the working area, it determines and records, when the light intensity value measured by its photosensitive sensor exceeds a light intensity threshold, a corresponding high intensity position of the robot. The robot further determines whether the battery power of the intelligent robot is lower than a power threshold, and, if yes, moves to any of the high intensity positions and the solar battery is charged by light energy. The high intensity position coordinates of the robot may be mapped with corresponding time points and the robot may move to a high intensity position mapped by a recorded time point closest to the current time point. The robot may, for recharging, also move to the position with the highest light intensity value mapped previously or, alternatively, to the nearest high intensity position. The robot may also only run during the day for instance between 8:00-17:00 and stand by during the night or a period of time without sunlight when the battery is too low, and will then automatically search for areas with light to charge when it is sunny in the morning. A search for the position with the highest light intensity value near the memorized coordinates avoids errors caused by the offset of the illumination position over time.

Plonski et al., “Environment and solar map construction for solar-powered mobile systems”, IEEE Transactions on Robotics, Vol. 32, No. 1, February 2016, discloses the theoretical construction of an environment and solar map for solar-driven mobile robots to compute energy efficient paths within a working area of the mobile robot. The purpose of these energy efficient trajectories is to harvest more solar energy for mobile robots operating in environments for a long time, where the environments have objects like trees of bushes cast varying shadows. The solar map of the working area of the mobile robot includes the expected (or: predicted or estimated) solar power (or: insolation or probability of sun) at a plurality of locations within the working area at various times during a day or longer period of time. The map is constructed using previous insolation measurements along with models about the environment and computing the estimated insolation for any position at any time. The robot may follow an algorithm with, in principle, arbitrary trajectories and plan its future energy efficient trajectories based on the estimate of the solar map.

EP 3 872 867 A1 discloses, in particular in par. 0152, a stored map of the working area to be used for navigating the robot in order to find a position where an illumination condition is relatively good. This position is marked and stored in the map in advance and then, during operation, found by means of navigating the mower robot using the map. An illumination condition of a location is determined by obtaining, by comparison, a relationship between the location of the automatic mower and the location at which an illumination condition at the location of the automatic mower is relatively good. Establishment of the map and comparison for a location relationship is implemented either (i) by satellite positioning and establishing a coordinate system or (ii) by using a method capturing an image with a camera or (iii) by using a method setting an RFID tag. Therefore, the RFID tag seems to be used to initially establish the data set, which is then used to navigate the robot later.

### General Disclosure of the Invention

An underlying problem (or: object) of the invention is to propose a new method for operating at least one autonomous robot and a corresponding new autonomous robot system, both in particular for working on (or: treating) vegetation, in particular lawns, wherein the autonomous robot uses, at least partially, electric energy converted from surrounding illuminating radiation, in particular sunlight. In particular the robot should be able to find a spot for recharging within the operating area in a way that is easy to implement.

A solution of this problem according to the invention is proposed by an embodiment according to any of the independent claims.

In the embodiments according to the independent claims 1 and 13 a method is suggested for operating at least one autonomous robot, in particular an autonomous vegetation working robot, preferably an autonomous lawn robot, within an operating area.

The robot typically comprises
(i) at least one electrically driven tool,
(ii) at least one electric motion drive for moving the robot,
(iii) at least one photoelectric device (or: photovoltaic unit) for converting energy from illuminating light, in particular sunlight, into electric energy (used or to be used) for the tool and the motion drive and
(iv) at least one energy storage, in particular one or several rechargeable batteries, for storing electric energy charged by the photoelectric device and for supplying the tool and the motion drive with electric energy.

The method comprises as a first step the normal operation of the robot. The robot works in an autonomous working mode, within at least one working area within the operating area. In the working mode typically both the tool and the motion drive are activated (or: switched on), and the robot uses electric energy supplied by the photoelectric device and often also energy supplied by the energy storage.

A second step of the method comprises determining (or: monitoring) an electric energy stored in the energy storage of the robot or a directly associated electric quantity such as electric capacity or electric charge of the energy storage. Preferably, determining the stored electric energy or associated electric quantity includes measuring, detecting or evaluating an electric output voltage or power of the energy storage.

The determined remaining or residual electric energy in the energy storage or the associated electric quantity is now compared with a minimum working threshold (or: level) for operating the robot in the working mode. The minimum working threshold is typically a predefined or stored threshold value, assuming an energy consumption when all electric consumers including the tool and the motion drive of the robot being activated as is the case when the robot is working. Preferably, the stored minimum working threshold can be adapted to the working conditions in the working area, for instance more slopes or higher grass etc. that may increase the average power consumption and thus the minimum threshold value.

If, as a result of that comparison, the determined stored energy or the directly associated electric quantity of the energy storage is found to be below the minimum operating threshold for operating the robot in the working mode, the robot moves or is moved to a charging position for recharging the energy storage using the photoelectric device, according to a third step of the method. The minimum operating threshold is chosen high enough or at a safety margin to allow for this (searching) movement of the robot to the charging position.

The charging position (or: high illumination position or position with high expected illumination or unshaded position) is a pre-determined (or: pre-defined) position chosen from one or more pre-defined or specific charging positions, where, at least for a minimum recharging time period, including a sequence of periods, required for recharging, the illumination intensity of the illuminating light will be higher than a high illumination threshold and/or where the illuminating light will essentially not be shaded by objects in or around the operating area, in particular vegetation objects such as hedges, bushes or trees or built objects such as buildings. There may be just one charging position or a plurality of charging positions the robot may search for when recharging is required.

The (at least one) charging position or each charging position is, according to the embodiment of claim 1, defined by a position marker (or: position token or position identifier) placed (or: located, arranged) at the corresponding charging position.

The robot comprises a sensing device (or: detecting device) for sensing (or: detecting) the or each position marker.

Now, the robot, when moving or being moved to the charging position according to the third step, searches for the position marker using the sensing device and stops at the charging position when the sensing device senses the robot to be within the certain distance from the position marker.

The range may be a spatial range such as within a certain distance and/or a signal or field range, e.g. a range of a certain signal or field characteristic such as a strength or intensity.

In the prior art mentioned above it is known that robots may look for sunny spots with high sunlight intensity while operating during the day to improve energy efficiency and recharging. The known systems mentioned above use solar maps or illumination maps where such sunny spots or positions with high illumination intensity are marked as position coordinates within the map and are used when navigating according to this navigational map. Although these known methods are technically flexible and advantageous, they require to establish a navigational map of each working area including illumination data and need proper data communication for positional data during operation.

According to embodiments of the invention, a navigational map is not necessary, although not excluded. Rather, an easier way of defining charging positions for the robot is suggested by simply placing a position marker at the charging position, which charging position typically had been identified beforehand by a user, and have the robot search for that position marker. A user can now simply inspect the working area before starting the operation of the robot and look for unshaded and well illuminated spots for the charging position and place a position marker at at least one of these suitable spots. The user may also use a sun altitude app on a smart phone which uses the camera and the compass of the smart phone and shows the sun altitude and thus also the possible shading at the each position for each time of each day of the year and evaluate various positions within or close to the working area accordingly. Also the user can choose only such spots where the robot will be not in the way when recharging.

Comparing to the disclosure of EP 3 872 867 A1, this document does not disclose that the robot has a sensing device for sensing the RFID tag and that the robot, by using the sensing means, searches for the RFID tag by using the sensing device and stops when the sensing device senses the robot to be within a certain distance from the RFID tag. Rather, the RFID tag seems to be used to initially establish a well-illuminated position within the navigational map, which is then used to navigate the robot.

By the term “vegetation” any configuration or arrangement or cover of plants that grow, mainly in the spring and summer season, when sufficient sunlight and water is present, is comprised, including, without loss of generality, lawns, gardens, park areas, golf courses, woods, copses, groves, agricultural fields, vineyards, green houses or modern city buildings with integrated horizontal and vertical agriculture etc. The vegetation may in particular, without loss of generality, be decorative or ornamental or be used as a ground surface or as a fence or be used for gaining food or medicine or building or industrial materials or fabrics. The plants, therefore, include all kind of cultivars or agricultural or horticultural plants or crop and also wild plants or species or varieties, in particular, without loss of generality, grass or weed or bushes or trees or agricultural plants, in grown or mature form or as seedlings etc.

By a “lawn” any surface is meant with grass or weed or other plants that grow, mainly in the spring and summer season, when sufficient sunlight and water is present, and can be cut regularly, including sowed lawns as well as wild grown meadows or grassland and anything in between.

The robot working on the vegetation (in the working mode) includes, without loss of generality, working activities to influence vegetation, its healthy growth, shape and constitution, including gardening or agricultural activities like cutting, mulching, scarifying, collecting items such as leaves, cut off grass or even golf balls, trimming, irrigating, fertilizing, sowing or harvesting, pesticide or herbicide spraying or video monitoring.

What partial spectra (wavelengths, frequencies) of the illuminating light, in particular sunlight, will be converted by the photovoltaic unit and to what extent (conversion rate), depends on the material and type of the photovoltaic device chosen. The term “light” includes electromagnetic radiation in the visible spectrum, typically from about 400 nm to about 800 nm wavelength, and in the infrared (IR) spectrum, preferably in the near infrared spectrum from about 800 nm to about 1200 nm wavelength.

Regarding the modus operandi during the working mode, the robot may, in most of the embodiments or applications, be moving on the ground by means of ground moving units such as wheels or rolls or legs or crawlers and corresponding driving and steering devices or units, usually electric motors with transmission units such as gears. However, in some embodiments, it is also possible that the robot may be flying or moving through the air during the operation, alternatively or in addition to a ground movement, and may then be equipped with flying drives like e.g. drones, including for example propellers and electric drive motors.

Usually, the robot further comprises at least one control device for controlling the tool and the motion drive and, in particular in a centralized system, for navigating the robot within the operating area and/or preferably for energy management of the electric energy stored in the energy storage and the electric energy supplied to the tool and the motion drive. The robot may (further or alternatively) comprise, in particular in a distributed system, a remote communication device for communicating with external control devices and/or signal or information sources for navigation or optionally for energy management.

Advantageous embodiments and improvements according to the invention are disclosed in the dependent claims.

In a preferred embodiment, the at least one or each position marker is placed within the operating area or within the at least one working area, in particular by a user, preferably on or in or at the edge of a lawn, but also other positions are possible for instance at fences, walls, buildings, bodies, or pavements or trees for instance.

In an advantageous embodiment the at least one position marker is portable, thus making it easy to place the position marker at various different charging positions by a user, at the first installation but also in particular in case of changes in the environment within or close to the operating area or weather conditions.

The position marker, preferably in order for it to not be removed or displaced by the robot or humans or animals, may be removeably fixed at the charging position, in particular by means of an anchor or peg or the like or by burying it at the ground surface or by gluing or releasably fixing it to an object in or next to the operating area. Preferably at least one position marker may be used at or moved between different charging positions.

The position of the position marker may however also be identified by an external sensing device such as a drone and transmitted as data to the robot's navigational system or the drone might even pick up the robot and carry it to the charging position and back or even place the position marker.

There are various embodiments of the technology and design and construction of the position marker.

In general and in preferred embodiments, at least one position marker may have a passive configuration, i.e. the position marker changes or sends back a signal emitted by the robot, for instance like a transponder or in optical or radar or ultrasound systems where the potion marker only reflects the signals or also in image systems taking images of the position marker.

The at least one position marker may also have an active configuration, i.e. the position marker sends out a signal or field, e.g. a magnetic field or electromagnetic signal or field, which is sensed by the robot or an external system such as a drone.

In a preferred embodiment at least one or each position marker contains permanent magnetic material and/or is made as a magnetic strip or magnetic disk or magnetic body in general and the sensing device of the robot contains a magnetic field sensor for sensing the magnetic field of the position marker. The certain distance of the robot from the position marker may then correspond to a certain magnetic field strength and/or magnetic field direction sensed by the sensing device. Such a magnetic embodiment of the position marker is very robust and reliable and does usually not deteriorate in its function due to dirt or weather conditions such as temperature or humidity. In a modification, as a magnetic position marker an electromagnet, for instance a coil or loop supplied with an electric current, may be employed for producing an induction magnetic field to be sensed by the sensing device of the robot.

The magnetic field sensor or, in general the sensing device, is preferably arranged in front and/or in the middle of the robot in order to achieve a defined alignment with respect to the position marker and, preferably with respect to the sun, at the charging position.

In a further embodiment, the (sensing of and) searching for at least one position marker, in particular using the sensing device of the robot, are based on signaling technology using electromagnetic or sound signals, in particular RFID technology or NFC or Bluetooth or ultrasound technology or radar technology, wherein in particular the certain distance of the robot from the position marker corresponds to a certain signal intensity or other signal characteristics such as phase differences or signal running times. If it needs energy battery included beacons (solar cells for recharging and even inductive recharging by robot time of flight search for maximum strength

In a further embodiment, the searching for the at least one position marker is based on pattern recognition technology, in particular optical pattern recognition or image recognition identifying the image of the position marker or identifying identification patterns at the position marker such as, for instance, QR codes or numbers and letters or logos or colours. The pattern recognition is performed preferably using the sensing device and possibly also an external recognition system the sensing device of the robot is in communication with, and wherein in particular the certain distance of the robot from the position marker corresponds to a focal distance or other optical characteristics sensed by the sensing device. The images and pattern recognition may also be performed by an external optical or image capturing device, for instance a drone, and the positional data of the position marker is then transferred to the robot. In particular in such an embodiment it may be possible to also use an existing object within the operating area, such as for instance a characteristic stone or architectural object or a characteristic tree, as a position marker.

In a further embodiment the method comprises the following further steps determining the electric energy stored in the energy storage or the associated electric quantity and comparing the stored energy or associated electric quantity with the minimum operating threshold is performed repeatedly, in particular regularly within given time intervals of typically between 1 second and 5 minutes.

Normally, during the autonomous working mode the tool and the motion drive are both activated. During the searching movement, when the robot moves or is moved to the charging position, the tool of the robot may be deactivated and the motion drive activated. But it is also possible that the tool of the robot stays activated to use also the searching movement for working activity. When the robot has reached the charging position, the robot goes into a stand-by mode, wherein in the stand-by mode the tool and the motion drive of the robot are usually both deactivated.

In a preferred embodiment the robot, when or after stopping at the charging position, preferably within a certain distance from the position marker, directly enters a charging mode during which the energy storage is charged by the photoelectric device.

In a further embodiment, for a situation of expected or imminent darkness, the robot may first enter a darkness mode or stand-by mode and wait for the end of the darkness for recharging.

In such an embodiment the charging position or at least one of the charging positions is a wake up position, where the robot moving to and after reaching the wake up position will wait in stand-by mode until the darkness period is over. The wake-up position (or: sleeping position) is a, usually pre-determined (or: pre-defined), charging position, as defined above, where the high illumination condition will be fulfilled a predicted or expected condition after the darkness period, e.g. illuminating light appearing or shining after the period of darkness, usually sunlight in the morning or after sunrise, which will not be shaded by objects in or around the operating area, for a predetermined wake-up period or of the robot including the minimum recharging time period required.

In order to enter such a darkness routine or mode, darkness information is received (in particular by the robot or another component of the system), the darkness information indicating or including that the intensity of the illuminating light is already below a minimum charging intensity, which is necessary for charging the energy storage by the photoelectric device, or will be below such a minimum charging intensity for a certain period of darkness, usually the night or another period without sunlight such as heavy clouding or rain.

If the remaining energy in the energy storage is below the minimum operating threshold and if at the same time, having receiving darkness information or based on the received darkness information, the photoelectric device will not be able to recharge the energy storage robot for the upcoming period of darkness the robot will wait in stand-by mode at the wake-up position as the charging position, until the illuminating light intensity is high enough again after the period of darkness to recharge the energy storage.

The darkness information is preferably chosen to be at least one of
(i) an information indicating a low or zero illuminating light intensity, preferably derived from the electric output of the photoelectric device of the robot or derived from measurements using a light sensor, which is preferably carried by the robot,
(ii) a time and date indicating the beginning of darkness such as sunset or vanishing sunlight and the duration of darkness such as the time until the next sunrise or appearance of sunlight,
(iii) a weather reporting information indicating the beginning of darkness by weather conditions such as heavy clouds or rain,
(iv) an end of work time (or stop work time) of a time schedule, in particular a time schedule set daily or for a specific date or week day, the end of work time indicating the time when the robot is to stop working,
(v) information about a working or mowing period concluded or done,
(vi) sensor and sensor algorithm information no more need for cutting for the time being, for example cutting resistance sensors,
(vii) command from user or back-end service to cease operation.

In a preferred embodiment, the robot stays at the charging position or wake-up position until the photovoltaic device has recharged the energy storage sufficiently, in particular so that the stored energy or the directly associated electric quantity of the energy storage is above the minimum operating threshold by a sufficient margin, and then resumes operating in the working mode. In a wake-up routine after the period of darkness, when the intensity of the illuminating light is above the minimum charging intensity, the robot usually stays at the wake-up position until the photovoltaic device has recharged the energy storage sufficiently, so that the stored energy or the directly associated electric quantity of the energy storage is at a wake-up value above the minimum operating threshold and, preferably, when the wake-up value is reached, the robot resumes operating in the working mode.

In a preferred embodiment, in an adjustment or alignment procedure, the direction and orientation of the robot and its photoelectric device at the charging position or wake-up position is adjusted towards the source of the illuminating light, in particular the sun, in order to increase or optimize the intensity area density of the incident illuminating light on the surface of the photoelectric device, in particular by movement of the robot with the photoelectric device and/or by movement of the photoelectric device relative to a robot chassis.

An adjustment of the azimuth orientation (azimuthal adjustment) is preferably achieved by a rotating or turning movement of the robot at the charging position or wake-up position. When the robot arrives at the respective charging position it performs a rotating or turning or circling movement about its vertical axis by at least one full turn or revolution and during this full turn or revolution the output of the photoelectric device is monitored. The robot is then oriented at or close to the rotational position or azimuth angle where the maximum output was identified.

Thereby, the orthogonal axis of the photoelectric device is oriented at the current azimuth angle of the sun and thus at the currently best azimuthal position, but may also be rotated slightly more to optimize over the charging time interval.

In a preferred embodiment, which can be combined with the azimuthal adjustment, the inclination of the surface of the photoelectric device towards the sun is optimized or at least improved, preferably so that the normal or orthogonal axis of the surface of the photoelectric device is inclined at the elevation angle of the sun or at least as close as possible to it, preferably within the variation or range of the elevation angle during the growth season (elevation adjustment). The inclination angle of the surface of the photoelectric device is preferably equal to or as close as possible to 90° minus the elevation angle of the sun, which elevation angle is 90° minus the latitude angle plus the declination angle of the sun.

In a further variant of the invention according to optionally independent claim 13 the method comprises instead of or in addition to the use of a position marker (in particular according to features e) and f) of claim 1) the selection of a suitable position at a slope or sloped surface of the operating area as a charging position or wake up position, wherein the slope angle of the slope is selected such that the inclination angle of the photoelectric device towards the source of the illuminating light, in particular the sun, is optimized with respect to the intensity area density of the incident illuminating light on the surface of the photoelectric device, when the robot stops at that charging position at the slope. That way a slope in the operating area can be advantageously installed or used to orient the photovoltaic device towards the sun or illumination source with respect to an increased efficiency without the need for a drive and mechanism for tilting the photovoltaic device, thus achieving an easier design with less costs and less demanding maintenance. This embodiment is a preferred embodiment of an elevation adjustment.

The slope may already be present or may be formed within a lawn or other surface, such as paved or asphalt or concrete or wooden or fine gravel or soil surfaces or the like, within the operating area or working area. Especially with a surface that can be easily formed such as lawn or gravel or soil the inclination of the slope can even be adjusted through the year to match the elevation of the sun even better. Also several charging positions with differently inclined slopes can be provided for different times of the year or the day. Also a ramp element with a fixed or adjustable inclination angle may be used which is adapted in size to the robot and can be placed at a suitable charging position. For instance, as a ramp element, an inclined plate can be used that is supported by supporting elements that can be varied in height.

The photoelectric device may alternatively or in addition also be inclined to the robot chassis or driving plane by an internal inclination angle to adjust to the elevation of the sun.

Therefore, preferably, at least a part of the photoelectric device may be arranged at a fixed, not tiltable or pivotable, orientation with respect to the robot chassis, even in a sealed or tight manner. The inclination angle of the photoelectric device of the robot towards the source of the illuminating light, in particular the sun, preferably after azimuth optimization, is the sum of the slope angle of the slope at the charging position and the internal inclination angle of the photoelectric device. Thus, this combined inclination angle may also easily reach the inclination necessary for a deeper or smaller elevation angle of the sun in early spring or late autumn.

In an advantageous embodiment, several charging positions or wake-up positions are defined within or close to the operating area, in particular to decrease the distance and time for the robot to find one of the charging or wake-up positions and/or to provide different charging or wake-up positions for different dates during the year or at different seasons of the year.

Preferably, at least one unshaded charging position is provided at a slope or a steeper slope of the operating area for summer and at least one unshaded charging position is provided at an essentially horizontal surface or a less steep slope of the operating area for spring or autumn.

In an embodiment, different position markers are provided for different charging positions or wake up positions in order to distinguish the different positions from each other. In another embodiment, identical position markers are provided for different charging positions or wake up positions, which for instance facilitates the sensing device of the robot. Also a position marker may be moved by a user between different charging or wake up positions during the year.

The position marker may also be shaped in such a way as to allow for the robot to stand in a certain direction in the charging position which direction is defined by the position marker. The position marker may extend over a certain length or dimension area to define a charging position and/or to be found more easily.

This may be advantageous for example with regard to the relative position of the robot with respect to the illuminating light, in particular the sun position. For instance the position marker may be formed by an elongated magnetic strip and the robot will follow a constant magnetic field strength defining a line parallel to the longitudinal axis of the magnetic strip as the direction of the robot in the charging position. Many other embodiments are feasible for the position marker to define a direction for the robot to stand in in the charging position.

A position marker for one charging position or wake up position may also be formed of several partial position markers, preferably forming an arrangement or pattern on the working area, in particular on the lawn, for instance a pattern which defines a direction for the robot to stand in in the charging position.

For instance without loss of generality, the robot may determine the distance to several partial position markers and derive a position with equal distance to each partial position marker, thereby in the case of two partial position markers stopping along a line in between the two partial position markers defining a direction for the robot in the charging position or wake up position. Or the position marker may consist of two or more magnetic partial position markers with opposite polarity so that at a zero line in the intermediate region between the two magnetic partial position markers their magnetic fields by superposition compensate to zero and this zero line may define a direction of the robot when the robot stops between the two partial position markers.

Many searching routines are suitable and can be implemented for searching the position marker and be integrated into or follow the normal navigational routines and movement patterns applied during normal operation of the robot, such as random search routines or following certain search pattern such as parallel lines in a meandered fashion or spirals or zick-zack movements etc. Preferably the robot simply continues its working operation, for instance mowing operation, also while searching for the charging position and its position marker.

In an embodiment, in order to find the position marker reliably, the robot may also follow a border cable which defines the border of a working area, and the position marker(s) may then be placed close to or above the border cable within that working area if there is a highly illuminated position which can serve as a charging position in the vicinity of the border cable. Therefore, if the robot gets the warning that the determined stored energy or the directly associated electric quantity of the energy storage is below the minimum operating threshold the robot may look for (or: search for) the border cable or the bordering signal within the border cable in as such well known procedures and may then follow the border cable until it finds the (next) position marker. Instead of a border cable the robot may in some embodiments also follow a guide cable leading to the position marker(s) comparable to finding a charging station in known embodiments.

At the rare occasion that at the time, when the energy level is found to be below the minimum energy threshold, the robot is already positioned at a predetermined charging position, i.e. at the corresponding position marker, the robot will stay at this charging position for recharging.

It is understood that, as is usual in autonomous systems, any of the conditions and steps taken on the fulfillment or non-fulfillment of a condition according to the invention may be of lower priority than higher priority conditions such as for instance failure or hazard detection. The method according to the invention is however carried out in the absence of such higher priority conditions.

In an embodiment, in particular according to claim 15, an autonomous robot system is suggested comprising
a) at least one autonomous robot, in particular an autonomous vegetation working robot, preferably an autonomous lawn robot, within an operating area, the robot comprising
a1) at least one electric tool,
a2) at least one electric motion drive for moving the robot,
a3) at least one photoelectric device for converting energy from illuminating light, in particular sunlight, into electric energy and
a4) at least one energy storage for storing electric energy charged by the photoelectric device and for supplying the tool and the motion drive with electric energy;
b) the system with the robot being configured to carry out a method according to any of the embodiments according to the invention or any of the claims and
c) comprising and at least one position marker.

The embodiments disclosed herein are only examples, and the scope of this disclosure is not limited to them. Particular embodiments may include all, some, or none of the components, elements, features, functions, operations, or steps of the embodiments disclosed herein. Embodiments according to the invention are in particular disclosed in the attached claims directed to a method and a system, wherein any feature mentioned in one claim category, e.g. method or system, can be claimed in another claim category, e.g. storage medium, system, and computer program product as well. The dependencies or references back in the attached claims are chosen for formal reasons only. However any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

### Exemplary Embodiments

The invention will, in the following, be described further with reference to exemplary embodiments, also referring to the schematic drawings.

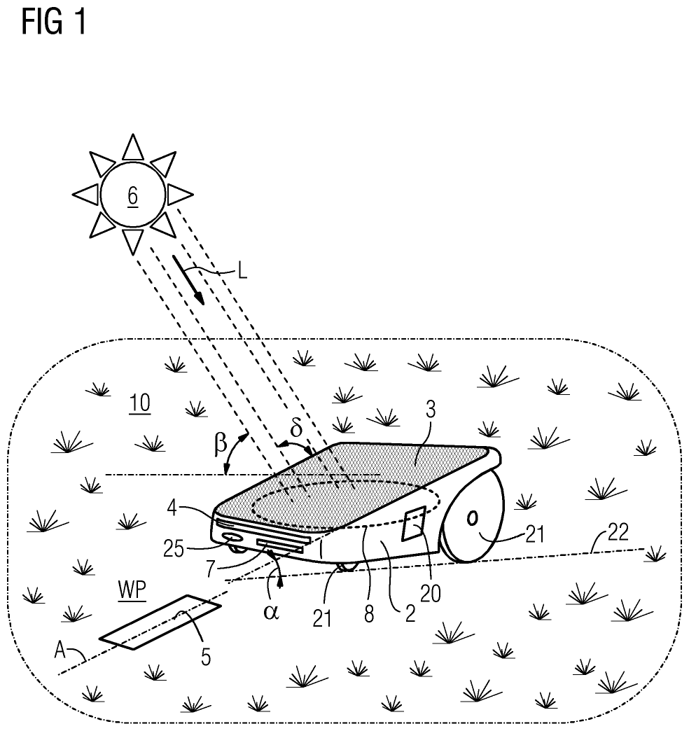

FIG. 1 shows a vegetation working robot with a photovoltaic device in a selected charging or wake-up position defined by a position marker

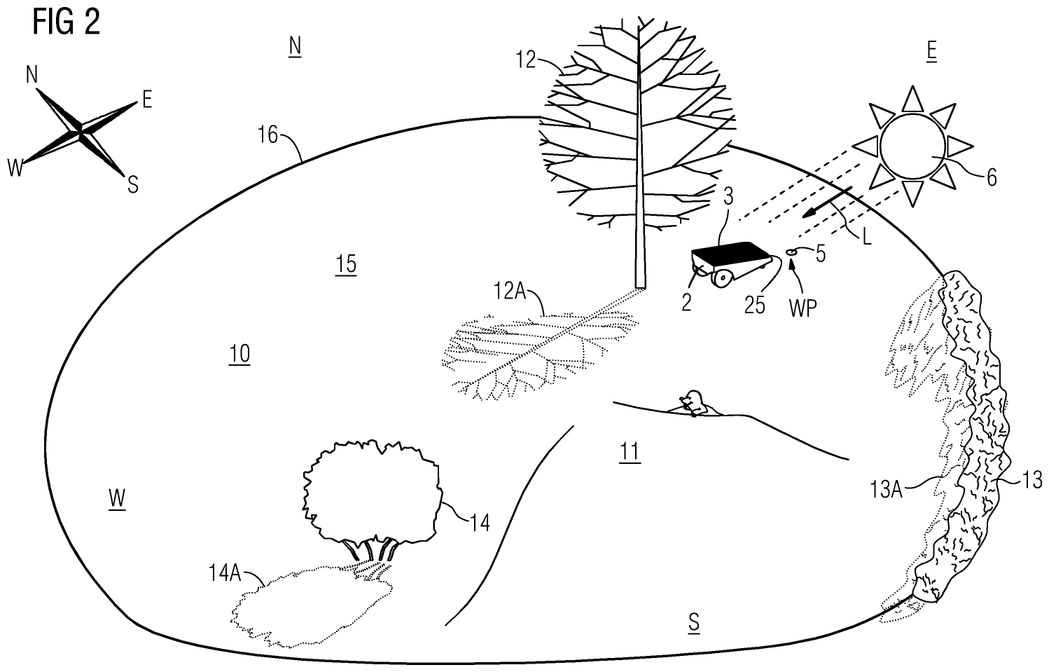

FIG. 2 shows a vegetation working robot with a photovoltaic device in a selected wake-up (or: starting) position defined by a position marker, as shown in FIG. 1, within a vegetation working area in the morning when the sun is still in the East,

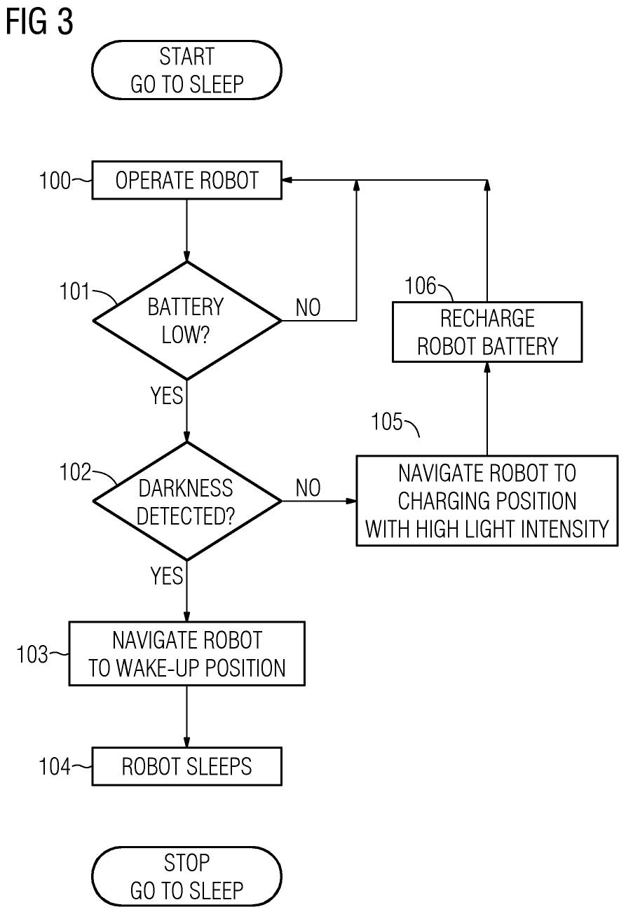

FIG. 3 shows a go-to-sleep routine for a vegetation working robot in a flow diagram,

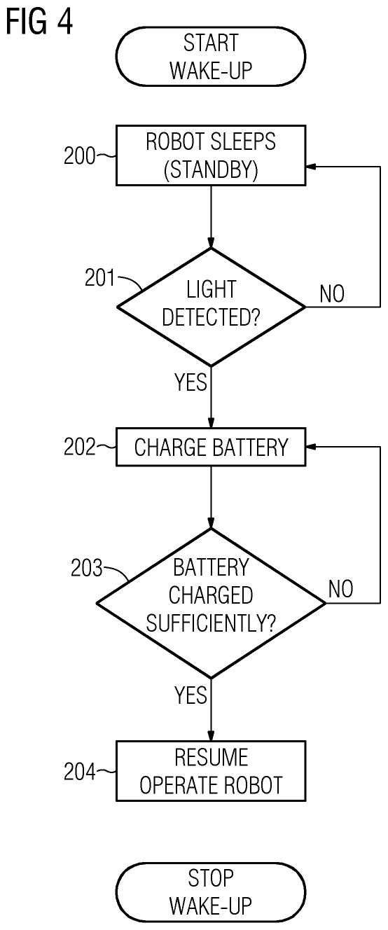

FIG. 4 shows a wake-up routine for a vegetation working robot after a go-to-sleep routine according to FIG. 3 in a flow diagram,

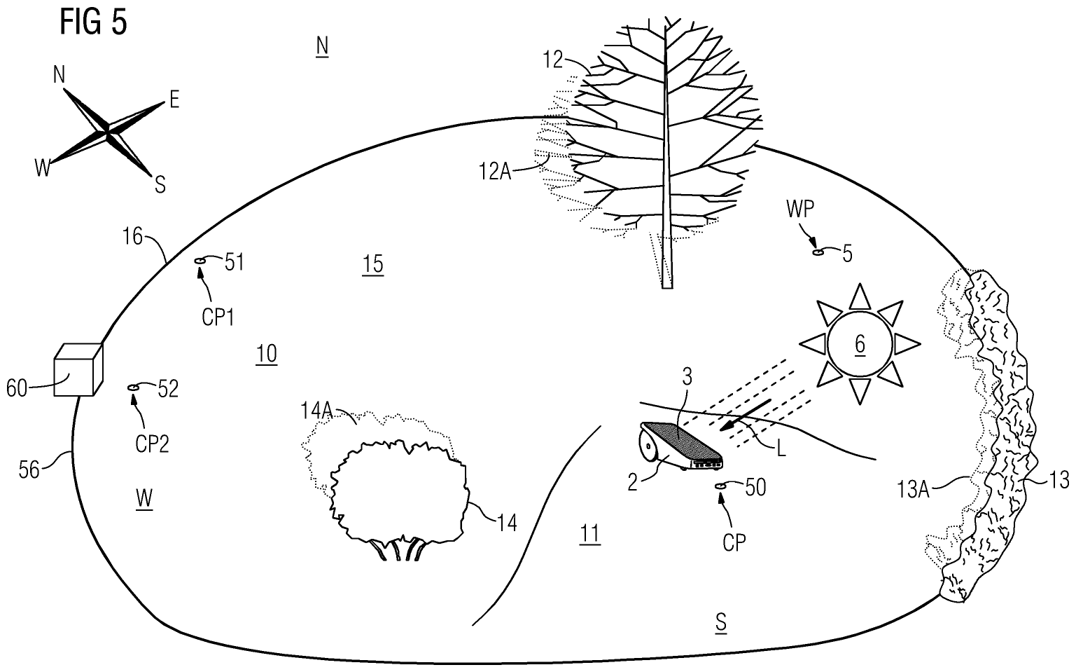

FIG. 5 shows a vegetation working robot with a photovoltaic device in a selected charging position defined by a position marker at a slope within a vegetation working area closer to noon when the sun is in South-East,

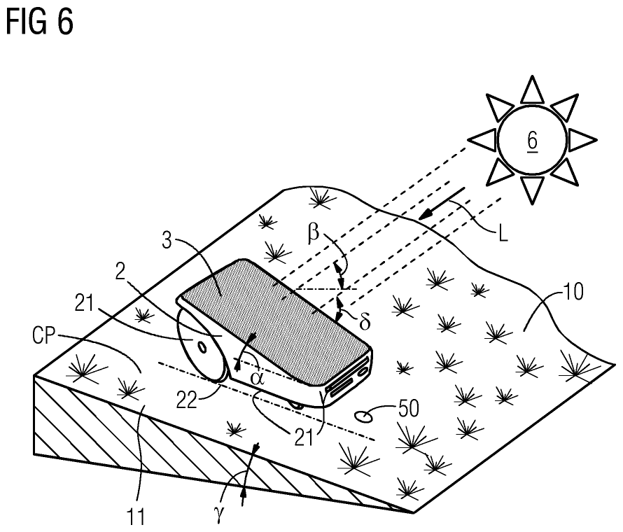

FIG. 6 shows the robot at the charging position at the slope of FIG. 5 in an enlarged view and

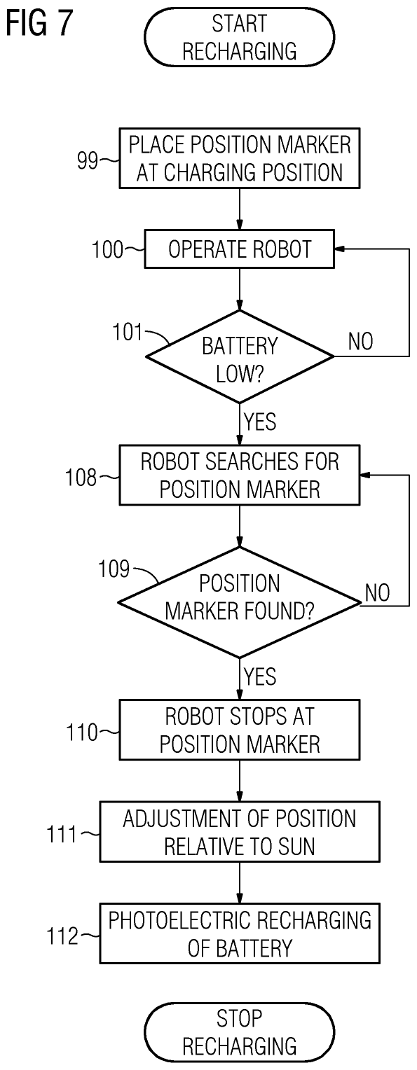

FIG. 7 depicts a recharging routine with a position marker in a flow diagram.

Corresponding entities, parts and quantities are designated by the same reference signs in the figures if not indicated otherwise.

In FIGS. 1 and 2 and FIGS. 5 and 6 an autonomous vegetation working robot, in particular lawn robot 2, is shown with ground wheels 21 driven by an electric motion drive 20 comprising at least one electric drive motor for moving the robot 2 on and over a surface of a lawn 10 within a pre-determined operating area, esp. working area 15, and according to autonomous navigation algorithms or routines provided by a navigational system. The ground wheels 21 standing on a surface of the working area 15, here the lawn 10, define a driving plane 22 or a chassis plane of the robot chassis.

The working area 15 is confined by a border 16 which may be defined by a bordering wire or border cable 56 or beacons or mapping or obstacles such as walls or hedges or other known systems. Besides the lawn 10 the working area 15 comprises other vegetation such as for example trees or bushes or hedges. Examples of a tree 12, a hedge 13 and a bush 14 are depicted in FIG. 2. Also an operating area for the robot with several working areas may be provided (not shown).

The robot 2 has at least one electrically driven working tool 8 for working on the lawn 10 including an electric tool drive comprising at least one electric tool drive motor. The tool 8 comprises in particular a cutting tool or blade(s), in particular rotating and/or pivoting blades or cutting tool, for mowing or cutting the lawn 10 and possibly, in addition or alternatively, a mulching tool and/or scarifying tool.

The navigational system for the robot 2 typically comprises navigational software, implemented in a control device 7 of the robot 2 alone or, in a distributed system, in control hardware in the robot 2 and external hardware, the control device or hardware typically comprising at least one digital processor and digital storage for digital data processing. The robot 2 further comprises sensor and/or communication equipment sensing and/or transmitting and receiving signals used for navigation. The signals used for navigation may, without loss of generality, be position or positioning signals from positioning systems or signals from bordering wires or beacons. A sensor 25 is provided as part of a sensing device at the robot 2 for sensing a position marker 5 which will be explained further hereinafter. Suitable positioning systems are, without loss of generality, Real-Time Kinematic (RTK) positioning, Global Positioning System (GPS) positioning, Differential Global Positioning System (D-GPS) positioning or Ultra-Wideband (UWB) positioning systems and/or other positioning systems like for instance the system known from WO 2021/209277 A1 (LONA) and/or local electromagnetic, in particular radiofrequency (RF), emitter or beacon systems, such as Bluetooth, Near-Field Communication (NFC) or radio-frequency identification (RFID) technology based systems, with corresponding emitters or beacons at the working area or also signals from wires defining borders (bordering wire) of the working area or paths (guide wire) within the working area. Any of the navigational systems known per se from the state of the art may be used for guiding and navigating the robot 2 within its working area.

The robot 2 comprises one or several rechargeable batteries as energy storage 4 for storing electric energy and at least one photoelectric device (or: photovoltaic device or module) 3, usually comprising several photoelectric or photovoltaic cells for converting light energy, in particular sunlight L of the sun 6, into electric energy by means of the photoelectric effect and for supplying the electric energy directly to the electric consumers in the robot 2 and/or to the batteries for recharging.

A great variety of photoelectric devices or cells are suitable and can be used for the robot 2 together with suitable electronic converters or power controllers. The photoelectric device 3 or its cells are preferably based on p-n-junctions or diodes of semiconductor materials such as, mostly monocrystalline or polycrystalline Silicon (Si) or, esp. in thin film technology, GaAs, ZnSe or CdS, which generate an output photoelectric voltage and change their electric impedance depending on the intensity of the incident light. The photoelectric device 3 may, topologically, be composed of a contiguous illumination area (or: surface) or several disjunct or disjoint illumination areas (or: surfaces) and each area may be composed of one or more parts or cells. The photoelectric device 3 may be made rigid or of rigid cells and mounted onto the robot 2. Also photoelectric material flexible in shape may be used for the photoelectric device 3 such as photoelectric foils or solar membranes or photoelectric coatings or thin-film photovoltaics applied onto the housing of the robot 2.

The robot or photoelectric device 3 may also be equipped with orienting (or: aligning) drives for orienting the illumination surface(s) of the photovoltaic device 3 towards the light source, typically the sun. The photoelectric device 3 may also include means for increasing or decreasing its illumination area for instance folding or pivoting means for several photoelectric device parts joint together by joints (not shown). As the maximum illumination area of the photoelectric device 3 is limited, a photoelectric device 3 or cells with high efficiency or photoelectric conversion rate is or are chosen. Further, albeit small, losses occur in the converter electronics associated with the photoelectric device 3. The peak power of the photoelectric device 3 at maximum light intensity available at the working area may vary a lot depending on the type and size of the robot, but may typically be in the range of 5 W to 300 W. The peak power consumed by all electric consumers of the robot 2 simultaneously may for instance be in the range of 18 to 500 W.

Therefore, usually, with the power needed at some instances of time for the mechanical tools and drives of the robot 2 and also its electronics, operating the robot 2 with photovoltaics alone without any batteries is not feasible over the working period and for a reasonably large working area and the rechargeable batteries are needed for buffering and smoothing the power supply. The photoelectric device 3 does not necessarily have to supply the maximum electric power or power peaks of the robot 2 on its own as the (charged) batteries provide additional electric power. Nevertheless, the photoelectric device 3 should, in a fully energy autonomous embodiment, provide at least the overall or accumulated energy for a given working period and given working area and desired working result (e.g. keeping the lawn maintained), so that no external charging means become necessary. Of course, if the photoelectric or solar recharging is not sufficient, a hybrid solution with external recharging in a charging station, in particular equipped with stationary solar cells itself, is also possible, and/or a plug in cable or manual recharging in case of emergency.

The rechargeable batteries of the energy storage 4 of the robot 2 are preferably Lithium-ion (Li-ion) batteries, in particular because of their high energy-to-weight ratio, low memory effect and slow self-discharge, although other materials for the batteries are also possible. Typically battery packs of several (Li-ion) battery cells grouped and switched together to achieve the desired total battery voltage and in order to achieve the desired electric capacity or electric discharge current. The geometric configuration of the battery pack can be adapted to the shape and space within the robot 2. Voltage, capacity, life duration, thermal stability and safety of a (lithium-ion) battery cell depend on the material chosen for the anode, cathode, and electrolyte. The capacity and size of the batteries selected depends on the maximum discharge current needed for supplying the electric power for the working tool(s) and/or the drive system and the control unit(s). The electric power is approximately the product of the battery discharge voltage and the discharge current at the various instants of time. The capacity of the battery determines the overall electric energy, i.e. the time integral over the electric power, the robot 2 may consume during one working cycle until recharging is needed. A higher electric capacity of the batteries is typically needed for covering a larger working area. Typically, the maximum electric capacity of the batteries of the robot 2 may be selected in a range from 1 Wh to 300 Wh.

The robot 2 further comprises a battery monitoring system which monitors the remaining capacity or charge of the batteries. This is an embodiment of determining an electric energy stored in the energy storage of the robot or a directly associated electric quantity such as electric capacity or electric charge of the energy storage.

When the capacity or charge C(t) at an instant of time t drops below a minimum working capacity or charge threshold Cₘᵢₙ, i.e. C(t)<Cₘᵢₙ, the working tool operation of the robot 2 is stopped and the robot 2 needs recharging of its batteries. This is an embodiment of determining an electric energy stored in the energy storage of the robot or a directly associated electric quantity such as electric capacity or electric charge of the energy storage (the step d) mentioned above).

When the capacity or charge C(t) however drops down below a critical minimum capacity or charge threshold C_{cr}, in particular before the waiting position is reached, the robot 2 is stopped immediately to save the batteries from deep discharge which would not allow recharging again and to keep a high life duration. The critical minimum capacity or charge threshold C_{cr} is smaller than the minimum working capacity or charge threshold Cₘᵢₙ. The minimum working capacity or charge Cₘᵢₙ of the batteries of the robot 2 is chosen large enough to still allow for some movement of the robot 2 towards a recharging position. Typical values for the critical minimum capacity or charge threshold C_{cr} are 2 to 10% of the maximum capacity or charge of the batteries and for the minimum working capacity or charge threshold Cₘᵢₙ 10 to 25% of the maximum capacity or charge of the batteries. The minimum working capacity as well as a maximum charging capacity may be chosen to achieve a long lifetime of the batteries, so that the charge of the batteries may be kept for instance between approximately 15% to 90%, preferably 20% to 80%, of the maximum capacity.

There are several methods known per se for determining or estimating the actual remaining capacity or charge and thus the remaining electric energy of a battery by the battery management system. The remaining charge or capacity (measured in Ah or C) and is a direct measure for the remaining electric energy (measured in J or Wh) that can be supplied by the battery; at constant output voltage U the remaining electric energy E is E=C U. The State of Charge (SOC) is the ratio of the remaining charge or capacity and the maximum or rated charge or capacity of a battery. In order to determine the remaining charge or capacity or the SOC known battery or energy management systems may use various SOC estimation methods for instance using MPPT (Maximum Power Point Tracking) or current integration (Coulomb counting) or Kalman filters or Neural Networks or impedance measurement or output voltage measurement (terminal voltage) or combinations thereof, in particular using the converters or electronics of the energy management system. For evaluating the SOC or the remaining electric energy electric parameters like the voltage, current, capacity, impedance, charging/discharging rate may be used and the temperature band chemical type of the battery be taken into account as well. Also State of Health (SOH) calculations or estimations can be taken into account.

The robot 2 also comprises a photoelectric monitoring system which monitors the photoelectric output voltage Vₒᵤₜ of the photoelectric device 3.

The photoelectric output voltage Vₒᵤₜ may, in one embodiment, be compared with a minimum voltage threshold Vₘᵢₙ which corresponds to a low light intensity of the illuminating light or sunlight L or too dim light for recharging the batteries. If the photoelectric monitoring system detects that the photoelectric output voltage Vₒᵤₜ drops and stays below the minimum voltage threshold Vₘᵢₙ and/or decreases further down to 0 V within a specified (minimum) monitoring interval Δt of e.g. 1 to 15 minutes after a starting time t₀, i.e. Vₒᵤₜ(t)<Vₘᵢₙ for t₀<t<t₀+Δt, this event or condition is interpreted by the navigational system of the robot as entering a dark period or a period of darkness with a longer lack of light, esp. lack of sunlight L such as nightfall or in general as a period without (sufficient) sunlight, e.g. due to heavy clouds or rain. Alternatively or in addition entering of a period of darkness may be detected also by an illumination sensor comprised by the robot 2 which yields a corresponding low intensity signal when the light has faded and the darkness begun.

So, a general condition for entering a period of darkness is I(t)<Iₘᵢₙ for t₀<t<t₀+Δt with the light intensity I(t) at a time t, the minimum intensity threshold Iₘᵢₙ, the starting time to and the detecting or monitoring time interval Δt. The monitoring time interval Δt is chosen long enough so that a nightfall or sunset can be distinguished from shades for instance when driving under a dense bush and shades do not lead to switching off the tool of the robot 2 all the time. The length of the monitoring time interval Δt should however not be too long so that the batteries are not discharged too much during the monitoring interval. In general, the monitoring time interval Δt may be chosen between 5 and 60 minutes. Another possibility of detecting the entering of a period of darkness is monitoring the time derivative of the light intensity dI/dt, i.e. how fast it decreases over time t, which allows for distinction between a rather sudden decrease when entering shades and a slower decrease at sunset or nightfall. Also, as another possibility, comparing the output signals of different cells of the photovoltaic device cells may be used and if the output voltages of all cells simultaneously drop below the minimum voltage threshold this is an indication of sunset or nightfall and if, on the other hand, the output voltages of only some of the cells drop below the minimum voltage threshold and of the other cells do not this is an indication of entering just a shade during the day.

These embodiments are examples for receiving darkness information that the intensity of the illuminating light is or will (soon) be below a minimum charging intensity, which is necessary for charging the energy storage by the photoelectric device, for a certain period of darkness, usually the night or another period without sunlight such as heavy clouding.

The darkness information may also be obtained directly from schedule time information and/or weather forecast information. An example of a schedule time information is a scheduling time table week schedule or day schedule which defines operating hours or time (which may for example depend also on rest hours during noon for neighbours or working hours of staff etc.) and which can be set by a user, for instance by means of the user interface on the robot or an app for a mobile device and/or can be set or rescheduled by the system for instance based on a weather forecast, defining non-working periods during a thunderstorm or heavy rain clouds. The darkness information will then be derived from the end of work time set for the present day. The robot will usually start moving to the wake up position a sufficient time earlier to reach the or the next wake up position before the end of work time as to fulfill the schedule and stop or having stopped working when the end of work time is reached.

Typically, in all embodiments, a period of darkness will be a night between sunset or one day and sunrise of the next day or a time of low light intensity such as heavy clouds or rain. But it is also possible to wait for a couple of days for instance over the weekend, if such a period of several days is defined as a pre-set non-working time period by a time schedule or by weather conditions, for instance when it is too dry or too wet or too windy for working or mowing. Then the robot will wait in stand-by mode at the wake up position until that pre-set non-working period is terminated. In other words a condition of higher priority such as a pre-set time schedule might shift the wake-up time to a time after more than one periods of darkness with daylight periods in between, but it will also after such a period of several days be at the wake-up position with sufficient light at the wake-up time.

FIG. 2 depicts a working area 15 in the morning or at a wake-up time shortly after sunrise of the sun 6 close to the geographic East E. Each of the higher or taller parts of vegetation cast, due to the low altitude of the sun comparatively long, shadows (or: shades) facing away from the sun 6, the tree 12 a shadow 12A, the hedge 13 a shadow 13A and the bush 14 a shadow 14A.

The wake-up position WP is chosen to lie outside of any of these shadows 12A, 13A and 14A of tree 12, hedge 13 or bush 14 (or any other obstacles that cast shadows) during at least a certain (predicted or expected) wake-up time period starting from the wake-up time darkness ending time t₂, which is larger than the charging time needed for recharging the batteries to reach the desired wake-up capacity or charge C_{wak}. The wake up time period (sunny charging period) starting from the darkness ending time or wake up time t₂ typically may comprise several minutes up to, preferably two, hours, for instance in the morning, and may be predicted depending on the desired recharging and the expected sun conditions. A preferred position for the wake-up position WP will be, without loss of generality and depending on the obstacles present, towards the East E or East-South-East of the working area 15 and thus in the geographic direction of the sun 6 as shown in FIG. 2.

According to embodiments of the invention special routines for recharging the batteries of the robot 2 are provided. This is shown also in the flow diagrams of FIGS. 3 and 4 for recharging at a wake-up position in case of a period of darkness and in the flow diagram of FIG. 7 for the general case of recharging at a charging position, also during the day.

A Go-to-sleep-routine is shown in FIG. 3. The robot 2 is operated in normal working mode, with the working tool(s) and the drive(s) and the navigation and control systems being powered with electric energy and working, as long as there is enough charge and illumination (STEP 100). The battery monitoring or management system permanently checks the charging status of the batteries of the robot 2 (STEP 101). If the battery charging status is ok and the battery is not low, i.e. in particular not below a minimum working capacity or charge Cₘᵢₙ, (STEP 101 NO), the robot 2 continues to operate in the working mode (STEP 100).

If, however, the battery charge is low, i.e. below a minimum working capacity or charge Cₘᵢₙ, and thus the batteries cannot provide enough electric energy required for working properly in the working mode for much longer, it is checked in a next step whether darkness is or has been detected (STEP 102). The entering of a period of darkness is monitored by a darkness detection system such as the photoelectric monitoring system or an illumination sensor as already described. If darkness is not detected (STEP 102 NO), i.e. there is still daylight available for recharging, the robot 2 either stays at the position for recharging or, preferably, is navigated to a recharging position with high light intensity, preferably with the tool being switched off or deactivated (STEP 105) and the batteries of the robot 2 are recharged at the recharging high intensity position by the photoelectric device (STEP 106) according to one of the routines known per se from the prior art.

If, however, darkness is detected at a point in time or darkness time t₁ (STEP 102 YES) and if, at the same time (in STEP 101) the battery monitoring system has detected a too low actual capacity or charge C(t₁) of the battery at this darkness time t₁, i.e. lower than the minimum working capacity or charge threshold Cₘᵢₙ, i.e. C(t₁)<Cₘᵢₙ, the robot 2 is, for example as the last activity in the twilight or darkness, navigated by the navigational system to a predetermined or pre-defined wake-up (or: waiting, sleeping) position (STEP 103). During that navigation to the wake-up position the robot may continue working in the working mode keeping the tool 8 switched on to use the movement for working operation or, if it is more important to save energy, may also discontinue working operation and switch off the tool 8. The robot 2 sleeps at the wake-up position, sleeping meaning going into a stand-by mode and switching off or deactivating all electric consumers apart from those control and monitoring systems needed for waking up or starting the robot 2 again when the darkness ends.

This is an exemplary embodiment of the robot, after receiving of darkness information and if the stored energy or the directly associated electric quantity of the energy storage is below the minimum operating threshold, moving to a wake-up position and going into a stand-by mode at the wake-up position during the period of darkness.

A wake-up routine will be explained next referring to FIG. 4. The robot 2 still sleeps (or: is in stand-by mode) at STEP 200. However, the photoelectric monitoring system or illumination sensor is active and monitors the intensity of light falling on the photoelectric device 3 (STEP 201). If light of sufficient intensity for recharging is not detected (STEP 201 NO), the robot stays in stand-by mode or continues to sleep (STEP 200). If light of sufficient intensity for recharging is detected (STEP 201 YES) at or after a darkness ending time t₂, meaning the photoelectric output voltage Vₒᵤₜ(t) exceeds the minimum voltage threshold Vₘᵢₙ for a time t with t₂<t, then the batteries are recharged (STEP 202), while the robot 2 stays or rests at the wake-up position.

The battery monitoring system permanently checks the charging status of the batteries (STEP 203). If the battery charging status is not ok yet and the battery is still too low (STEP 203 NO), i.e. in particular below the minimum working capacity or charge Cₘᵢₙ, the robot 2 remains in the charging mode and the batteries are charged further (STEP 202). If the battery charging status is ok or the battery sufficiently charged for restarting or waking up the robot 2, (STEP 203 YES), i.e. the capacity or charge of the battery is above a pre-defined wake-up capacity or charge C_{wak}, which is typically higher than the minimum working capacity or charge Cₘᵢₙ, the robot 2 resumes operating in the working mode, i.e. the working tool(s) and drive(s) and navigational system are powered or switched on again (STEP 204). The wake-up capacity or charge C_{wak} can be chosen within a wide range with the minimum working capacity or charge Cₘᵢₙ, typically being the lower boundary and a value close or equal to the maximum capacity or charge being the upper boundary. The range for wake-up capacity or charge C_{wak} typically comprises 15% to 90%, preferably 40% to 80%, of the maximum capacity or charge of the batteries.

The wake-up position is a charging position, where illuminating light after the period of darkness, usually sunlight in the morning or after sunrise, will essentially not be shaded by objects in or around the working area, in particular vegetation objects such as bushes or trees or built objects such as buildings, for a predetermined wake-up period of the robot. The wake-up position is, in other words, a position where illuminating light or sunlight is expected or predicted at a sufficiently high intensity after the period of darkness, for example where the sun or future sunshine most probably will appear next. Preferably, the wake-up position is a position or spot, where, after darkness has ended at a darkness ending time (or wake up time) t₂, the photoelectric device 3 will, due to the lack of shade, be exposed to illuminating light of sufficiently high intensity for recharging the batteries, the intensity I(t₂) at the darkness ending time t₂ and at the wake-up position being larger than the minimum intensity threshold Iₘᵢₙ for recharging and typically, at the darkness ending time t₂, not lying in a shadow of an obstacle between the light source, typically the sun, and the wake-up position.

As is shown in FIG. 5, alternatively or in addition, further charging positions CP, CP1 and CP 2 are provided within the working area 15 which may be used for different times of the day or the year. Each of the further charging positions CP, CP 1 and CP2 is defined by a corresponding position marker 50, 51 or 52. There are several ways of determining a suitable charging position CP or CP1 or CP2 or wake-up position WP as a special charging position.

Preferably, to find an optimal spot for the wake-up position WP or charging position CP or CP1 or CP2 the appearance and altitude of the sun (or: solar altitude) at the geographic location of the working area 15 at and the shadows which obstacles situated on or near the working area 1 cast onto the working area 15 are observed or calculated for each day during a certain working period and the wake-up position is chosen (empirically) in an area where there is direct sunlight without shadows of obstacles. The observations are made empirically by measurement or video or human visual observation, for instance by means of a sun altitude app. The calculations are typically based on models or simulations as are known per se for instance from the prior art mentioned above.

FIG. 5 depicts the working area 15 around noon when the sun 6 is close to the geographic South S. Each of the higher or taller parts of vegetation cast, now shorter, shadows (or: shades) facing away from the sun 6, the tree 12 the shadow 12A, the hedge 13 the shadow 13A and the bush 14 the shadow 14A.

The wake-up positions WP and charging positions CP and CP 1 and CP2 are chosen as shadow-free spots within the working area 15. The shadows such as the shadows 12A, 13A and 14A of objects such as 12, 13 and 14 within or in the vicinity of the working area 15 follow the sun's path or arc during a day, so that the position and shapes of shadows of objects that do not change their position and shape can be precisely predicted at each time of each day of the year using ray geometry or simply by observation or using a sun path predicting app. As a complementary consideration the prediction of the shadows yields of course also the prediction of shadow-free areas within the working area during each time of each day so that suitable shadow-free spots at a specified day time period at a specified date of the calendar can be identified for the charging positions CP, CP1 or CP2 or wake-up positions WP.

The sun path at the sky during a day (caused by the Earth's rotation) follows an arc with an elevation angle or altitude starting at zero at sunrise, i.e. in the horizontal plane, increasing up to its maximum above the horizontal plane when the sun is in the direction of the longitude, i.e. in the South on the Northern hemisphere (and in the North in the Southern hemisphere), and decreasing again down to zero at sunset, i.e. back in the horizontal plane. The azimuth angle of the sun's path or arc is measured in the horizontal plane with respect to the maximum elevation in the South where the azimuth is zero is negative and towards the East it and positive towards the West. The azimuth angle is −90° in the East and +90° in the West and 0° at the meridian or longitude. Due to the seasons (caused by the inclination of the Earth's rotational axis with respect to the ecliptic plane of the Earth's revolution around the sun) the total azimuth angle range as well as the elevation angle range of the arc of the sun both change between a maximum in the summer (summer solstice) and a minimum in the winter (winter solstice) which of course results in longer days with earlier sunrise and later sunset and higher sun altitude in the summer and shorter days with lower sun altitude in the winter. The variation in the elevation angle and azimuth angle ranges throughout the year depends on the latitude the working area is situated at. The elevation angle varies in the range from 90° minus the angle of the latitude plus the declination of the sun which is plus 23,44° (the earth's axis' inclination towards the ecliptic plane around the sun) at summer solstice and minus 23,44° at winter solstice and 0° at the two equinoxes, e.g. at a latitude of 49° or −49° between 64,44° at summer solstice (21 June) und 17,56° at winter solstice (21 December) and 51° at spring equinox (21/22 March) and autumn equinox (21/22 September).

In an advantageous embodiment, for increasing or optimizing the area density of the incident light intensity and thus the output of the photoelectric device 3, the surface or panels or cells of the photoelectric device 3 are directed or oriented towards the sun at the time of recharging at the respective wake-up position WP or other charging position CP or CP1 or CP2. This means that an optimal angle of incidence, preferably around or at least close to 90°, of the light L of the sun on the surface of the photoelectric device 3 should be achieved. Therefore, an orthogonal axis of the surface of the photoelectric device 3 is oriented as close as possible, preferably parallel to the position of the inclined axis of the sun, i.e. in the best case oriented at the same elevation angle and the same azimuth angle as the sun at that instant of time.

As can be seen best in FIG. 1 but also in FIG. 6, the illumination surface of the photoelectric device 3 is inclined under an inclination angle α with respect to the driving plane 22 or the robot chassis for better alignment or adjustment to the elevation angle β of the sun 6 or the angle of incidence δ of the light L of the sun 6, thereby increasing or optimizing the output of the photoelectric device. The angle of incidence δ is shown in FIG. 1 in the best possible or ideal orientation to be 90°.

A further adjustment to the sun position can be achieved in particular by a movement of the robot and/or by a movement of the photoelectric device relative to a robot body or chassis. In a preferred embodiment the following adjustment routines use only movements of the robot 2 or only the motion drive 20 of the robot 2.

When the robot arrives at the respective charging position CP or WP it stops and performs an azimuthal adjustment of its photoelectric device by rotating or turning or circling about a vertical axis by an (azimuth) angle of 360°, i.e. at least one full turn or revolution. During this full turn or revolution the effect or output of the photoelectric device 3 is monitored and a maximum output (or: highest output) during the rotation or turn and the corresponding rotational position or azimuth angle are identified. The robot is then rotated to the rotational position or azimuth angle, where the maximum output of the photoelectric device was observed or detected. Thereby, the orthogonal axis of the photoelectric device 3 is oriented at the current azimuth angle of the sun and thus at the currently best azimuthal position. The robot may in the azimuthal adjustment procedure also be rotated at an azimuth angle which is a bit, e.g. between 1% to 5%, further towards the West than the detected azimuth angle for maximum or highest output of the photoelectric device 3 corresponding to the current azimuth angle of the sun in order to optimize the light intensity density over the charging time interval without having to move the robot again during recharging. Alternatively, the azimuthal adjustment procedure can be repeated, preferably regularly, during the recharging procedure, to adjust the azimuth angle of the photoelectric device 3 to the actual azimuth angle of the sun and to follow the progress of the sun along its sun path.

In a preferred embodiment, an elevation or inclination adjustment is performed, in addition to or without the azimuthal adjustment. During the elevation adjustment the inclination of the surface of the photoelectric device 3 towards the sun is optimized or at least improved, preferably so that the normal or orthogonal axis of the surface of the photoelectric device 3 (normal incidence) is inclined at the elevation angle of the sun or at least as close as possible to it with respect to the horizontal plane. So the inclination angle of the surface of the photoelectric device 3 with respect to the horizontal plane is preferably equal to or as close as possible to 90° minus the elevation angle β of the sun.

In a first variant of the elevation adjustment, at least a part of or the whole of the photoelectric device 3 may be inclined with respect to the robot chassis or a driving plane by an internal inclination angle α, as is shown best in FIG. 1 and FIG. 6, thus providing an inclination towards the sun, for instance corresponding to average elevation angles of the sun during spring or early autumn, already when the robot 2 stands on a horizontal surface during recharging at the charging position, as is shown in FIG. 1. The photoelectric device 3 will be inclined towards the sun in the correct inclination direction after the optimization of the azimuth angle. Therefore, preferably the photoelectric device 3 may be arranged at a fixed not tiltable nor pivotable orientation with respect to a robot chassis, in particular at an orientation inclined at a fixed inclination or parallel to the working surface or robot chassis.

In a second and advantageous variant of an elevation adjustment, which can be used alone or in combination with the first variant, best shown in FIG. 6, at least one charging position is chosen at a specified slope 11 or sloped surface within the operating area or working area 15. The slope 11 or sloped surface is inclined at a slope angle γ to the horizontal plane and towards the sun at the corresponding times of the day. Thereby, the robot 2 and its chassis or driving plane 22 when standing at the slope 11 will be inclined under the slope angle γ with respect to the horizontal plane and so will be the photoelectric device 3 if it is parallel to the robot chassis. If the photoelectric device 3 is inclined with respect to the robot chassis under an inclination or tilting angle α already, according to the first variant, as shown for instance in FIG. 6, the photoelectric device 3 may be inclined in the charging position at the slope 11 under a total inclination angle to the horizontal plane which is the sum γ+α of the slope angle γ at the charging position and the internal inclination angle or tilting angle α of the photoelectric device with respect to the robot chassis or driving plane 22.

The azimuthal orientation of the slope is preferably chosen within the azimuthal angle range of the sun at the times of the year or day intended for recharging. For instance for a wake-up position the slope 11 may be oriented within an azimuth angle range close to East and for a charging position during the day the slope 11 may be oriented within an azimuth angle range close to the meridian or highest elevation of the sun. An azimuthal adjustment is, thus, not strictly necessary when a slope is used for recharging. Preferably, at least one unshaded charging position is provided at a slope or a steeper slope of the operating area for summer and at least one unshaded charging position is provided at an essentially horizontal surface or a less steep slope of the operating area for spring or autumn.

The resulting inclination angle by one or both of the variants is chosen or adapted preferably according to the growth or working season and according to the latitude of the working area, as closely as possibly matched to the sun elevation at the corresponding dates which is, as mentioned above, 90° minus the angle of the latitude plus the declination of the sun during that time of the year, so for instance at latitude 49° it may be for example in the range from 50° to 65°. An acceptable deviation of the inclination from the elevation of the sun tolerance would be for instance about 10°, so the inclination angle may preferably be in the range from 90° minus the elevation angle β of the sun plus or minus 10°. The angle of incidence δ of the photoelectric device 3 towards the sun light L is preferably δ=180°−α−γ and preferably chosen to be in a range from 120° to 60°, with 90° having the highest yield. The robot 2 may also stand slightly sideways or not facing completely downhill at the slope 11 to increase the holding forces and avoid slipping down.

Instead of, during azimuthal adjustment, rotating the whole robot 2 with the photoelectric device 3 it is also possible, as mentioned above already, to provide an electric rotational adjustment drive for rotating the photoelectric device 3 with respect to the chassis of the robot 2 and rotate just the photoelectric device 3 by 360° and identify the azimuth angle with the maximum output of the photoelectric device 3 that way. This allows for an adjustment also when little space is provided for rotating the whole robot and avoids tracks in the lawn caused by the rotating maneuver of the robot 2. Also an optimization of the inclination angle can be achieved by an electric tilting drive for tilting the photoelectric device 3 at various inclination angles with respect to the horizontal plane, typically in a range from 0° to 90°, and again monitoring the output of the photoelectric device 3 and choosing an inclination angle of the photoelectric device 3 where the output of the photoelectric device 3 is maximum or highest.

Adjusting the orientation of the photoelectric device 3 to the sun by moving the photoelectric device 3 with respect to the robot chassis or housing or driving plane using an electric adjustment drive allows for a continuous and precise adjustment following the path of the sun with low tolerances, but requires some intermediate space which can be filled by leaves or dirt over time possibly obstructing the adjustment movement. The maneuvering of the whole robot 2 for finding the best orientation towards the sun according to embodiments of the invention has the advantage that the photoelectric device 3 can be arranged fixedly on the robot 2, even, but not necessarily, in a tight or sealed arrangement, making this embodiment safer and less susceptible to malfunctions by leaves or dirt than moving the photoelectric device 3 by respective separate drive(s). Also no additional drive for the photoelectric device 3 is necessary.

The adjustment routine for the azimuth angle and the inclination or elevation angle, whether performed by moving the whole robot 2 or by moving just the photoelectric device 3, can be repeated once or more to follow or adjust to the course of the sun during a recharging procedure at the charging position or wake up position if desired.

These adjustment routines to optimize the angle of incidence of the sun light on the photoelectric device can be performed at a charging position independent of whether the charging position is defined by a position marker or by other means for instance by using illumination maps or otherwise recorded positional data for identifying highly illuminated and shade-free spots as is known per se in the prior art mentioned above.

According to embodiments of the invention the charging positions WP and CP and CP1 and CP2 are defined by a respective position marker (or: position token or position identifier) 5 or 50 or 51 or 52 which is placed or located or arranged at the corresponding charging position. The robot, when moving or being moved to the charging position, searches for the position marker and stops at the charging position within a certain distance from the position marker. The position markers 5, 50 and 51 are placed in the lawn 10 and removably fixed by means of an anchor or peg or the like or by burying it at the ground surface of the lawn 10. But also other positions are possible for instance at fences, walls, buildings, bodies, or pavements or trees for instance. Preferably at least one of the position markers 5, 50 to 52 is portable, thus making it easy to place the position marker at various different charging positions by a user, at the first installation but also in particular in case of changes in the environment within or close to the operating area or weather conditions.

An example of a recharging process at an arbitrary charging position such as CP or CP1 or CP2 is shown in FIG. 7. A position marker is placed at a corresponding charging position (STEP 99). Like in FIG. 3 the robot is operated (STEP 100) and the status of the battery (energy storage 4) checked (STEP 101) According to FIG. 7, if the battery is low (STEP 101 YES) the robot searches for the position marker (STEP 108). If the position marker is found (STEP 109 YES), the robot stops at the position marker (STEP 110) and, preferably, performs an adjustment of its position relative to the sun's position (STEP 111) as explained above and afterwards recharges the battery by means of the photoelectric device (STEP 112).

In a preferred embodiment, at least one or each position marker 5, 50, 51 or 52 contains permanent magnetic material and/or is made as a magnetic strip or magnetic disk or magnetic body in general and the sensing device of the robot contains a magnetic field sensor 25 for sensing the magnetic field of the position marker. The certain distance of the robot from the position marker may then correspond to or be replaced by a certain magnetic field strength sensed by the sensing device, resulting in a signal or field range instead of a spatial range for the case of a magnetic field which applies also to other types of signals or fields. Also an electromagnet, for instance a coil or loop supplied with an electric current, may be used.

The magnetic field sensor 25 is preferably arranged in front and/or in the middle of the robot in order to achieve a defined alignment with respect to the position marker and with respect to the sun.

Many other embodiments are possible for the position markers and the sensing device of the robot. In particular, signaling technology using electromagnetic or sound signals, in particular RFID technology or NFC or Bluetooth or ultrasound technology or radar technology, may be used wherein in particular the certain distance of the robot from the position marker corresponds to a certain signal intensity or other signal characteristics such as phase differences or signal running times. Furthermore, the searching for the at least one position marker may be based on pattern recognition technology, in particular optical pattern recognition or image recognition identifying the image of the position marker or identifying identification patterns at the position marker such as, for instance, QR code or numbers and letters or logos. The pattern recognition is performed preferably using the sensing device of the robot and possibly also an external recognition system the sensing device of the robot is in communication with, and wherein in particular the certain distance of the robot from the position marker corresponds to a focal distance or other optical characteristics sensed by the sensing device. The images and pattern recognition may also be performed by an external optical or image capturing device, for instance a drone, and the positional data of the position marker is then transferred to the robot. In particular in such an embodiment it may be possible to also use an existing object within the operating area, such as for instance a characteristic stone or architectural object or a characteristic tree, as a position marker.

Although different position markers are provided for different charging positions or wake up positions in order to distinguish the different positions from each other, it is also possible to use identical position markers for different charging positions or wake up positions, which for instance facilitates the sensing device of the robot. Also a position marker may be moved by a user between different charging or wake up positions during the year.

The position marker may also be shaped in such a way as to allow for the robot to stand in a certain direction in the charging position which direction is defined by the position marker. This may be advantageous for example with regard to the relative azimuthal position of the robot 2 with respect to the sun position. For instance the position marker may be formed by an elongated magnetic strip such as shown for the position marker 5 in FIG. 1 and the robot may follow a constant magnetic field strength along the longitudinal axis A of the magnetic strip of the position marker 5 as the direction of the robot 2 in the charging position.

Many searching routines are suitable and can be implemented for searching the position marker and be integrated into or follow the normal navigational routines and movement patterns applied during normal operation of the robot, such as random search routines or following certain search pattern such as parallel lines in a meandered fashion or spirals or zick-zack movements etc. Preferably, the navigational routines or algorithms used during the working mode are also used during the search routine for searching the position marker.

In an embodiment, in order to find the position marker reliably, the robot 2 may, as is shown in FIG. 5, also follow a border cable 56 which defines the border 16 of the working area 15, and the position marker(s) may then be placed close to or above the border cable 56 at a highly illuminated position which can serve as a charging position in the vicinity of the border cable 56. Such a position marker 51 is shown at the charging position CP1 in FIG. 5. A control station 60 provides the bordering cable 56 with border signals for the robot 2 so as not to cross the border 16 but may also serve as guiding signals for the robot 2 to follow the border cable 56. The robot 2 comprises a corresponding bordering signal sensing device. The control station 60 may also serve as a charging station by means of a position marker 52 arranged at the control station 60, for instance fixed at its wall facing the working area 15, defining another charging position CP2 for the robot 2.

It is understood that, as is usual in autonomous systems, any of the conditions and steps taken on the fulfillment or non-fulfillment of a condition according to the invention may be of lower priority than higher priority conditions such as for instance failure or hazard detection, critical charge conditions, or severe weather conditions or a time schedule defining non-working periods. The method according to the invention is however carried out in particular in the absence of such higher priority conditions, which usually rarely occur.

The invention is by no means delimited by or to the exemplary embodiments. Various other embodiments are also possible and fall within the scope of the invention. For instance, although the exemplary embodiments describe an autonomous vegetation working robot, in particular lawn robot 2, the invention can be applied also to other types of autonomous robots operating in an operating area, e.g. cleaning robots, service robots, surveillance or guarding robots, or any robots as described in the prior art mentioned in the beginning. Furthermore, other locomotion or propelling drive systems can be provided as well for moving the robot on ground as a ground robot, for instance rolls or balls or legs or chain drives instead or in addition to wheels, or air propelling drives, in the air, as a flying robot like a drone or as a carrier drone for flying the ground robot from one place to the other (not shown).

Instead of the sun 6 also artificial light sources may be used, for instance lights or lamps or floodlights, e.g. in an application for final cutting of lawn in sports like football, tennis or golf. The robot could also just comprise solar cells without rechargeable batteries or at most at least one capacitor or small buffer battery for smoothing the electric voltage or power. Finding a wake up position according to embodiments of the invention will be even more useful for such a pure solar robot as it has no safety margin by the batteries. The robot could also, instead of or in addition to rechargeable batteries, include power to fuel or power to hydrogen technology converting the electric energy to fuel such as methanol or methane or hydrogen for storage in form of chemical energy and using a fuel cell for converting the energy in the fuel or hydrogen back into electric energy esp. once such systems become small and light and efficient enough for such an autonomous robot.

### Designating Numerals

2 robot
3 photoelectric device
4 energy storage
5 position marker
6 sun
7 control device
8 tool
10 lawn
11 slope
12 tree
12A shade
13 hedge
13A shade
14 bush
14A shade
15 working area
16 border
20 motion drive
21 wheels
22 driving plane
25 sensing device
50 position marker
51, 52 position marker
56 border cable
60 control station
99 STEP
100 to 112 STEP
A azimuthal axis
AR azimuthal rotation
CP charging position
CP1, CP2 charging position
E East
L light
N North
S South
W West
WP wake-up position
α tilting angle
β elevation angle of the sun
γ slope angle
δ angle of incidence

1. A method for operating an autonomous robot within an operating area,
the autonomous robot comprising (i) an electrically driven tool, (ii) an electric motion drive for moving the autonomous robot, and (iii) a photoelectric device for converting energy from illuminating light into electric energy, and (iv) an energy storage device for storing electric energy charged by the photoelectric device and for supplying the tool and the motion drive with electric energy,
the method comprising the steps of
a) the autonomous robot working in an autonomous working mode within at least one working area within the operating area,
b) determining an electric energy stored in the energy storage device of the autonomous robot or a directly associated electric quantity of the energy storage device,
c) in response to the determined stored electric energy or the directly associated electric quantity of the energy storage device being below a minimum operating threshold, the autonomous robot moves or is moved to a charging position for recharging the energy storage device using the photoelectric device,
d) wherein the charging position is chosen from one or more positions, where, at least for a minimum recharging time period, an illumination intensity of illuminating light will be higher than a high illumination threshold and/or where the illuminating light will essentially not be shaded by objects in or around the operating area,
e) wherein the charging position is defined by a corresponding position marker placed at the charging position,
f) wherein the autonomous robot comprises a sensing device for sensing the position marker and wherein the autonomous robot, when moving or being moved to the charging position, searches for the position marker using the sensing device and stops when the sensing device senses the autonomous robot to be within a certain distance from the position marker.

2. The method according to claim 1, wherein the position marker is placed within the operating area or within the at least one working area by a user,
or
wherein the position marker is placed on or in or at an edge of a lawn
or
wherein the position marker is portable to be placed at various different charging positions in case of changes in the environment within or close to the operating area or weather conditions, or is removeably fixed at the charging position via an anchor or peg or by burying the position marker at the ground surface or by gluing or releasably fixing the position marker to an object in or next to the operating area,
wherein the position marker is used at or moved between the various different charging positions.

3. The method according to claim 1, wherein the position marker contains permanent magnetic material or is made as a magnetic strip or body and the sensing device of the autonomous robot contains a magnetic field sensor for sensing the magnetic field of the position marker, wherein the certain distance of the autonomous robot from the position marker corresponds to a certain magnetic field strength sensed by the sensing device or wherein the magnetic field sensor is arranged in front or in the middle of the autonomous robot.

4. The method according to claim 1, wherein the searching for the position marker using the sensing device of the autonomous robot is based on signaling technology using electromagnetic or sound signals, wherein the certain distance of the robot from the position marker corresponds to a certain signal intensity.

5. The method according to claim 1, wherein the searching for the position marker is based on optical pattern recognition or image recognition identifying an image of the position marker or identifying identification patterns at the position marker,
wherein the optical pattern recognition is performed using the sensing device and wherein the certain distance of the autonomous robot from the position marker corresponds to a focal distance or other optical characteristics sensed by the sensing device.

6. The method according to claim 1, wherein the position marker has a passive configuration to change or send back a signal emitted by the autonomous robot, or wherein the position marker has an active configuration and sends out a signal or field to be sensed.

7. The method according to claim 1, with at least one of the following further features or steps:
(i) determining the electric energy stored in the energy storage device or the associated electric quantity and comparing the electric stored energy or associated electric quantity with the minimum operating threshold is performed repeatedly within given time intervals of between 1 second and 5 minutes,
(ii) the autonomous robot, when or after stopping at the charging position within the certain distance from the position marker, enters a charging mode during which the energy storage device is charged by the photoelectric device,
(iii) during the autonomous working mode the electrically driven tool and the motion drive are both activated,
(iv) when the autonomous robot moves or is moved to the charging position, the electrically driven tool of the autonomous robot is deactivated and the motion drive is activated,
(v) when the autonomous robot moves or is moved to the charging position, the electrically driven tool of the autonomous robot is activated and the motion drive is activated,
(vi) when the autonomous robot has reached the charging position, the autonomous robot goes into a stand-by mode, wherein in the stand-by mode the electrically driven tool and the motion drive of the autonomous robot are both deactivated.

8. The method according to claim 1, further comprising the steps of
receiving darkness information that the illumination intensity of the illuminating light is or will be below a minimum charging intensity, which is necessary for charging the energy storage device by the photoelectric device, for a certain period of darkness,
the autonomous robot, having received the darkness information or based on the received darkness information, searching for or moving or being moved to a wake-up position,
wherein the wake-up position is a charging position, wherein the illuminating light after the period of darkness will essentially not be shaded by objects in or around the operating area for a predetermined wake-up time period of the autonomous robot, the wake-up time period including the minimum re-charging time period.

9. The method according to claim 8, wherein the darkness information is at least one of
(i) an information indicating a low or zero illuminating light intensity derived from the electric output of the photoelectric device of the autonomous robot or derived from measurements using a light sensor carried by the autonomous robot,
(ii) a time and date indicating the beginning of darkness and a duration of darkness,
(iii) a weather reporting information indicating the beginning of darkness by weather conditions,
(iv) an end of work time of a time schedule, the end of work time indicating the time when the robot is to stop working,
(v) information about a working or mowing period concluded or done,
(vi) sensor and sensor algorithm information no more need for cutting for the time being,
(vii) command from user or back-end service to cease operation.

10. The method according to claim 1, wherein several charging positions or wake-up positions are defined within or close to the operating area to decrease the distance and time for the autonomous robot to find one of the several charging positions or wake-up positions or to provide different charging or wake-up positions for different dates during the year or at different seasons of the year,
wherein
different position markers are provided for different charging positions or wake up positions in order to distinguish the different charging positions or wake up positions from each other
or
identical position markers are provided for the different charging positions or wake up positions.

11. The method according to claim 1,
wherein the direction and orientation of the autonomous robot and the photoelectric device at the charging position or wake-up position is adjusted towards a source of the illuminating light in order to increase or optimize an intensity area density of incident illuminating light on a surface of the photoelectric device by rotating movement of the autonomous robot or by tilting or rotating movement of the photoelectric device relative to a robot body or chassis
or
wherein the autonomous robot stays at the charging position or wake-up position until the photovoltaic device has recharged the energy storage device is above the minimum operating threshold by a sufficient margin, and then resumes operating in the working mode.

12. The method according to claim 1,
wherein the charging position is chosen at a slope with a slope angle within the operating area, wherein the slope angle is selected such that an inclination angle of the photoelectric device towards a source of the illuminating light is optimized or increased with respect to an intensity area density of the incident illuminating light on the surface of the photoelectric device, when the autonomous robot stops at the charging position.

13. The method according to claim 12, wherein at least a part of the photoelectric device is and arranged at a fixed not tiltable orientation with respect to a robot chassis,
or wherein the inclination angle of the photoelectric device of the autonomous robot toward the source of the illuminating light is a sum of the slope angle of the slope at the charging position and an additional tilting angle of the photoelectric device with respect to the slope or the robot chassis,
or wherein at least one charging position is chosen at a slope, for summer, and at least one further charging position is chosen at essentially horizontal or less sloped surface for spring or autumn,
or
wherein an azimuthal orientation of the slope is chosen within an azimuthal angle range of the sun at the times of the year or day intended for recharging.

14. An autonomous robot system comprising
a) an autonomous robot within an operating area,
the autonomous robot comprising
a1) an electric tool,
a2) an electric motion drive for moving the robot,
a3) at least one photoelectric device for converting energy from illuminating light into electric energy and
a4) at least one energy storage device for storing electric energy charged by the photoelectric device and for supplying the tool and the motion drive with electric energy;
b) the system with the autonomous robot being configured to carry out the method of claim 1 and
c) comprising the position marker.
